(19) United States
(12) Patent Application Publication
(10) Pub. No.: US 2014/0172684 A1
(43) Pub. Date: Jun. 19, 2014

(54) System and Method to Utilize Presumptions, Database Information, and/or User Defaults to Calculate Construction Lien, Notice, Bond Claim, and Other Construction Document Deadlines and Requirements

(71) Applicant: Scott Gerard Wolfe, Jr., New Orleans, LA (US)

(72) Inventor: Scott Gerard Wolfe, Jr., New Orleans, LA (US)

(21) Appl. No.: 14/104,430

(22) Filed: Dec. 12, 2013

Related U.S. Application Data
(60) Provisional application No. 61/737,167, filed on Dec. 14, 2012.

(51) Int. Cl. G06Q 40/02

(52) U.S. Cl. CPC G06Q 40/025
USPC 705/38

(57) ABSTRACT

A system and method to calculate construction lien, construction notice, bond claim, and other construction document requirements and deadlines based on system user provided information that may lack identification of critical data, by employing a system and method of utilizing presumptions, preexisting and dynamically building database information, user defaults, and/or other data elements, to supplement user provided information.

### CROSS REFERENCE TO RELATED APPLICATIONS

This Nonprovisonal Utility Patent Application claims benefit of a previously filed provisional patent under 35 USC 199(e), the application number of which is 61/737,167.

### BACKGROUND OF THE INVENTION

The present invention relates to the field of mechanics lien and bond claim compliance. Mechanics lien and bond claim compliance is an important compliance item for construction industry participants, including general contractors, subcontractors, other trade contractors, architects, engineers, suppliers, and others. The compliance framework, however, is extraordinarily complex, governed by statutes and case law that differs depending on a construction project's jurisdiction, and characteristics of the construction project itself.

Determining the compliance requirements for a particular construction project typically requires data about that project that is not keep in the ordinary course of business by construction project participants, either manually or within any other project management or accounting software used by said participant.

As examples of this, consider that mechanics lien and bond claim compliance requires knowledge about whether a project is commercial, new residential, owner-occupied residential, state, or federal in character, from a statutory standpoint. Many project management systems for contraction participants, as well as the participants themselves, do not track these distinctions in line with statutory definitions.

Furthermore, to comply with lien and bond claim laws, it is frequently required that participants send notification to a number of parties. While the participants may know and track some of these parties, they may not know them all or track them all. A sub-subcontractor, for example, may need to send a notification to a general contractor, a property owner, and to a lender, but may not know any of these parties.

Even when a construction participant knows the information, it may still be not practically useful since the information is not tracked with a software platform. Many accounting systems, project management systems, enterprise resource planning systems (ERPs), and similar systems do not contemplate the tracking of information for mechanics lien and bond claim management, and therefore, when a participant wants to make determinations of requirements or deadlines based on data housed in one of these systems, the data frequently lacks the detail required to draw the proper conclusions.

This invention, through a computer or computer program, uses a system and method to fill this data gap between what construction participants know or are able to store within the systems they use, and the data needed to properly and fully calculate a mechanics lien or bond claim compliance deadline.

### SUMMARY OF THE ART

### Mechanics Liens and Notices:

Those furnishing labor, materials and/or services to private, state and federal construction projects around the United States have possible “mechanic's lien” claims in the event they are unpaid for their contribution. Popularly referred to as a “mechanic's lien,” the legal remedy is also called a “claim of lien,” “materialmen's lien,” “property lien,” “contractor lien,” “construction lien,” “statement of claim and privilege,” “notice of claim of lien,” and “stop work order.” When the labor, materials or services are furnished to a construction project owned privately (non-governmental ownership), the lien is placed against the property itself. When the labor, materials or services are furnished to a state or federal construction project, a lien against the government owned property is typically not available, but instead a “lien” is made against a bond under the federal Miller Act or each individual state's “Little Miller Act.” This lien remedy, which goes by many names and has different characteristics depending on the construction project's type, is referred to herein collectively as a “mechanic's lien.”

While the ability to file a mechanic's lien is uniformly available across the United States and its territories, the laws regulating its filing differs from state-to-state. In addition to each state having unique mechanic's lien laws, within these laws different treatment is afforded to construction participants depending on their role in the project (i.e. original contractor, subcontractor, architect, supplier, equipment lessor, etc.), their tier in the project (i.e. their place in the contractual chain starting from the property owner or public entity commissioning work) and the type of construction project where services are furnished (i.e. commercial, residential, owner-occupied residential, industrial, oil & gas, state, federal, etc.).

To preserve one's right to file a mechanics lien, many states require project participants to meet pre-lien statutory notice requirements. In some states, notices are required before services are provided, and in others notices are required within a certain period before the lien is filed. In other states, notices are not required at all. These notices must meet statutory requirements, and must be sent according to the state's statutory service or delivery standards. These construction notices, including, but are not limited to, notices of the following names and types: preliminary notices, pre-lien notices, notices to owner, notices of commencement, notices of intent to lien, notices of furnishing labor/materials, notices of lease, model disclosures, notices of completion or cessation, notices of lease, etc. Similar to a mechanic's lien, each state has specific requirements for how and when notices must be filed, served, or sent, to whom notices must be filed, served, or sent, and what must be included on the notice. These notices differ from mechanic's liens in that notices are only preliminary documents necessary to retain the right to claim a mechanic's lien at a later date, or optionally sent to notify or warn a recipient about the right to claim a mechanic's lien at a later date. The notices, collectively herein referred to as “preliminary notices” or “construction notices,” where and when required, may be necessary to a claim a mechanic's lien, but are not sufficient, by themselves, for a mechanic's lien.

Each notice has specific and varied legal requirements, regarding who is to be given notice, how they must be given notice, and when the notice must be given. In some states, the notices are required to be given on a recurring basis for every month in which the potential lien claimants is unpaid for their work. The legal requirements for construction notices also vary by the role of the party giving notice (i.e. general contractor, subcontractor, material supplier, equipment lessor, etc.), as well as by the state in which the project was located, and the project type (i.e. commercial, residential, public, etc.).

The act of filing a mechanics lien is also subject to varied legal requirements, with each state setting forth specific elements required within a mechanic's lien. After a lien is filed, many states require the mechanic's lien be served upon certain parties through pre-defined methods.

Finally, the mechanic's lien is a temporary encumbrance on private property or a surety bond. The encumbrance lasts for a specific period of time as provided by each jurisdiction's statute, and the encumbrance expires at the end of this time period unless action is taken by the lien claimant. In some jurisdictions, the mechanic's lien claim may be “extended” through a supplemental filing. When unable to extend or further extend a lien, the mechanic's lien claim must be “foreclosed upon” by filing an action seeking foreclosure in a designated court of law.

Construction Projects and Participants

The construction industry is one of the largest industries in the United States, and includes a variety of parties who engage in the construction or alteration of any improvement projects.

Improvement projects may be of a variety of “types,” which include residential projects, commercial projects, industrial projects, state owned projects or works, federally owned projects works, and more. Throughout this application, this will be referred to as a “project type.”

A variety of parties participate in the construction or alteration of said improvement projects. Parties are identified by the roles they play on an improvement project, and may be classified as a developer or owner, a general contractor, construction manager, architect, engineer, subcontractor, trade contractor, supplier, sub-subcontractor, sub- sub-subcontractor, sub-sub-sub-subcontractor, equipment rental company or equipment lessor, lender, mortgagor, lien agent, or more. Throughout this application, this will be referred to as a “role.” Throughout this application, the project as a whole will be referred to as a “project” or “construction project.”

Web Applications, Product Ordering Interfaces, Mobile Applications, Widgets, Communications Networks:

The World Wide Web (WWW) is a well-known network of computers, whereby users around the world can access information displayed within a web browser. Typically the user accesses certain web pages that are displayed to the user through the HTML (Hyper-Text Markup Language) protocol. The user calls and retrieves specific HTML pages by requesting the page through a known URL (Uniform Resource Locator) using HTTP (HyperText Transfer Protocol).

Using certain computer languages such as PHP, Javascript, and HTML, listed here illustratively only and as examples, it has become common for companies and individuals to write applications that run and operate through web browsers on the World Wide Web. These web applications are similar to software applications that are written to operate on a user's desktop, except that they run through web browsers on the web.

Typically, a user will visit a certain website and be required to login to their account. Once logged in, the user will have access to the web application and its features. A web application can be designed to appear on a web browser access via a personal computer, or on a “mobile browser,” which is a web browser optimized for viewing on a mobile device.

Although web applications viewing on a standard web browser may be viewed on a mobile device through a mobile web browser, mobile devices also have the ability to run native mobile applications. These applications are optimized to operate on a mobile device (such as an iPhone or iPad, or an Android OS device) with or without the use of an Internet connection. The user opens the application on his or her mobile device and is able to view, alter and interact with the application without the use of a browser.

Next, a Product Ordering Interface is an interface on the WWW that a user accesses through an HTTP request. Here, the user will find the ability to order certain products from the website, including, in the instance of this invention, mechanic's liens, bond claim forms, preliminary notices, lien cancellations, and similar products.

A popular Product Ordering Interface is the “shopping cart” model, whereby a purchaser selects an item from an electronic catalog, which is electronically added to the purchaser's “shopping cart”, and when the purchaser is done selecting items all the orders in the shopping cart are “checked out” when the purchaser provides its billing and/or payment information.

Another Product Ordering Interface that is also popular is the less-sophisticated form-based system, whereby the purchaser selects the product or service through an electronic catalog of services or products, and is then forwarded to an online form where information about the purchaser (including, perhaps, the billing and payment information) is gathered.

Finally, a “widget” is a term of art defined by Wikipedia as “a small application that can be installed and executed within a web page by an end user.” Or more further described therein as “a stand-alone application that can be embedded into third party sites by any user on a page where they have rights of authorship.” Other terms used to describe web widgets include: portlet, gadget, badge, module, webjit, capsule, snippet, mini and flake.

A widget may be installed on any web page, displaying content to the viewer, or offering a certain application or function to the viewer. When an application or function is offered, the widget runs a script stored on the originating server, such that the viewer is able to complete a function within the widget without the host-site storing the function's code and framework.

For the purposes of this Specification, all of these applications, interfaces and networks, together with other non-discussed offline software systems and electronic communications, are collectively referred to as the “System” or “Application.”

Deadline Calculators and Lien Deadline Information Databases

For quite some time, individuals and companies have offered resources to help construction participants understand and calculate the timeframe available to them to file construction notices, liens and bond claims across the country.

Most of these resources have been in paper format, simply separating the lien laws and lien law charts by state, and providing readers with a table of contents to the data. Some paper resources are more sophisticated, allowing users to move cardboard forms within a cardboard capsule so that a particular state will display in a carved out window; when a state is selected, that state's lien laws (or a summary thereof) will be displayed. An example device or paper resource to help calculate a deadline can be found in US Patent Application 20060069600 A1.

Still, however, the reader would have to decipher which laws apply to their particular station. Further, these lien law summaries are merely a compilation of the lien laws across the United States and its territories.

With the advent of computer software and the Internet, lien law resources have gotten a bit more usable.

Software users and web visitors have a few options where they can use computer databases to decode some of the lien law information. For instance, a user using one of these databases can select their state and be shown the general lien law in that state. In another instance, which is more specific, the user may use a software application to house detailed information about their construction project and the system will—after gathering all this project information--ask the user to provide generic work performance dates and/or answer pre-programmed questions about the project, and from all this information, display more specific database information about the construction project's applicable lien laws.

In addition to applications and database information systems that provide information about lien laws, there are a variety of generic date/deadline calculators in the marketplace. These calculators typically calculate a set number of days, months or years from a given date, and schedule notifications when the deadline approaches. An example generic date calculator is described in U.S. Pat. No. 8,140,605 B2.

Different arts have unique requirements for date calculating and the rendering of deadlines. The management of court dates and court dockets, for example, requires a lot of date and deadline management in a unique way. U.S. Pat. No. 7,171,416 B2 is an example of a method and apparatus to calculate court dates for a specific art (“calculating dates of different legal events capable of occurring in the course of a legal proceeding”) based on the varying calculation rules of each court jurisdiction.

In the art of construction lien and bond claim deadlines, US Patent 20130185177 and US Patent 20130191255 provide for more specific functionality with regard to calculating construction lien, construction notice, and other construction document deadlines.

In the calculation of deadlines, all prior arts require that certain information be present to perform the calculation or determination. There is a lack of prior art in systems, methods, or processes of calculating deadline requirements when the requisite information is missing by leveraging other known or provided information to accomplish the calculation.

Summary of the Art: Construction Lien and Notices Services

Law firms, attorneys, form companies, software companies, legal document preparation companies, and similar service and product providers offer services or products to contractors, owners, suppliers, architects, engineers and other construction participants that aid them with filing construction lien and notices, and/or managing lien and bond claim compliance. Construction liens and notices are form-driven documents, meaning that when filed or delivered, they are simply forms filled-in with the applicable information. The form varies from state-to-state, and also varies depending on other factors related to a subject construction project, including, but not limited to, the “type” of project, the role that the party is engaged on the project, and their tier in the construction contracting chain. The differences in the forms applicable to a party's particular circumstance depend on a large number of variables, which when spread across the country, creates a significant variety of form-types that can be used for all the different construction liens and notices that may be filed.

Many companies sell forms online or in paper format at retail locations, or over the Internet. The customer's experience is that the user searches for the type of form they need (without a significant degree of help or instruction), buy the form, and fill it in with the applicable information. The forms are static, and offered as packaged only.

Other companies, commonly known as legal document preparation companies or document automation companies, will collect information from the customer, and then fill-in the form for them. In the construction industry, and particularly with regard to construction liens and notices, it is also common for these companies to deliver or file the form after completion as part of the service. Some providers will fill in the information on the form manually for a customer, and others will use some type of software product or document automation tool to generate the document.

Attorneys and law firms offer legal advice and the preparation of legal documents, which may include the preparation of legal forms.

Finally, some companies sell software that will generate forms for the customer using document automation technology.

These services and service providers are distinguished from this Invention in that, while these service providers may have use for this Invention, they do not have a method and system, using a computer or computer program, for calculating and determining construction lien and bond claim requirements when data is provided but missing key pieces, by leveraging other known or provided information to accomplish the calculation.

### BRIEF SUMMARY OF THE INVENTION

This invention, through a computer or computer program, is calculate construction lien, construction notice, bond claim, and other construction document requirements and deadlines based on system user provided information that may lack identification of critical data, by employing a system and method of utilizing presumptions, preexisting and dynamically building database information, user defaults, and/or other data elements, to supplement user provided information.

This invention is applicable to businesses (i) who are construction project participants and need to comply with lien and bond claim requirements (i.e. subcontractors, suppliers, etc.); (ii) are in the business of preparing and sending or filing construction documents, including liens, bond claims, or notices, on behalf of other businesses (i.e. Construction lien and notice companies; (iii) who publish or use software and/or other tools, applications, or platforms to assist in the preparation and sending of construction notices, liens, bond claims, and other construction documents (i.e. construction project management systems, notice and lien management system, document assembly tools, accounting applications, etc.); and (iv) who publish or use software that calculates or determines, using any method, the lien or bond claim deadlines applicable to a user or a user's project.

This invention is beneficial to these potential users, and others, because it provides a system and method to streamline and automate the determination of critical compliance dates and requirements using accessible or available data.

### BRIEF DESCRIPTION OF DRAWINGS

FIG. 1 shows a graphical demonstration of the method and process contemplated by this invention, whereby certain information may be missing from a project record, and is supplemented with user default data, or if not available, presumptive data, all to perform the function of calculating a mechanics lien or bond claim deadline or requirement.

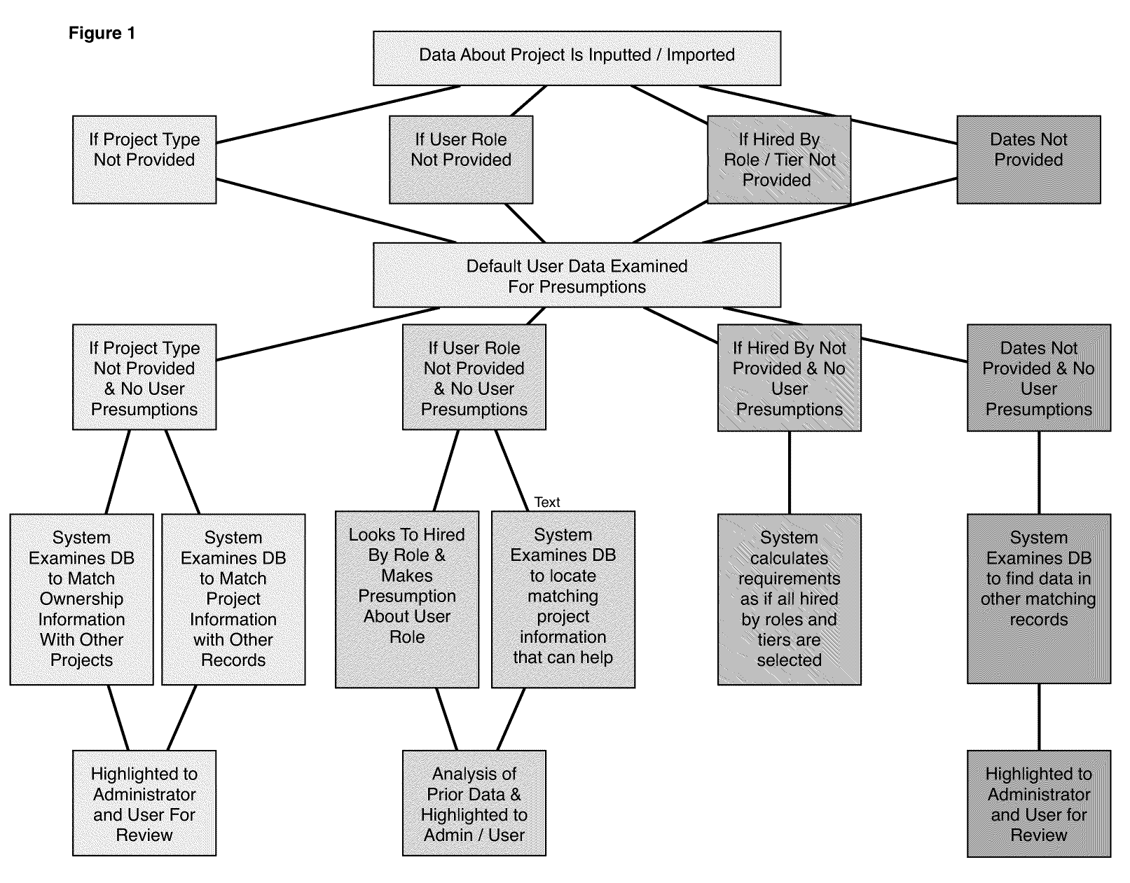

FIG. 2 is a graphical representations that specifically reviews how the user role function can be presumed with a hiring role indication, serving as an example of how such an administrative “if” and “then” rule could be established with regards to the relationship between these two roles.

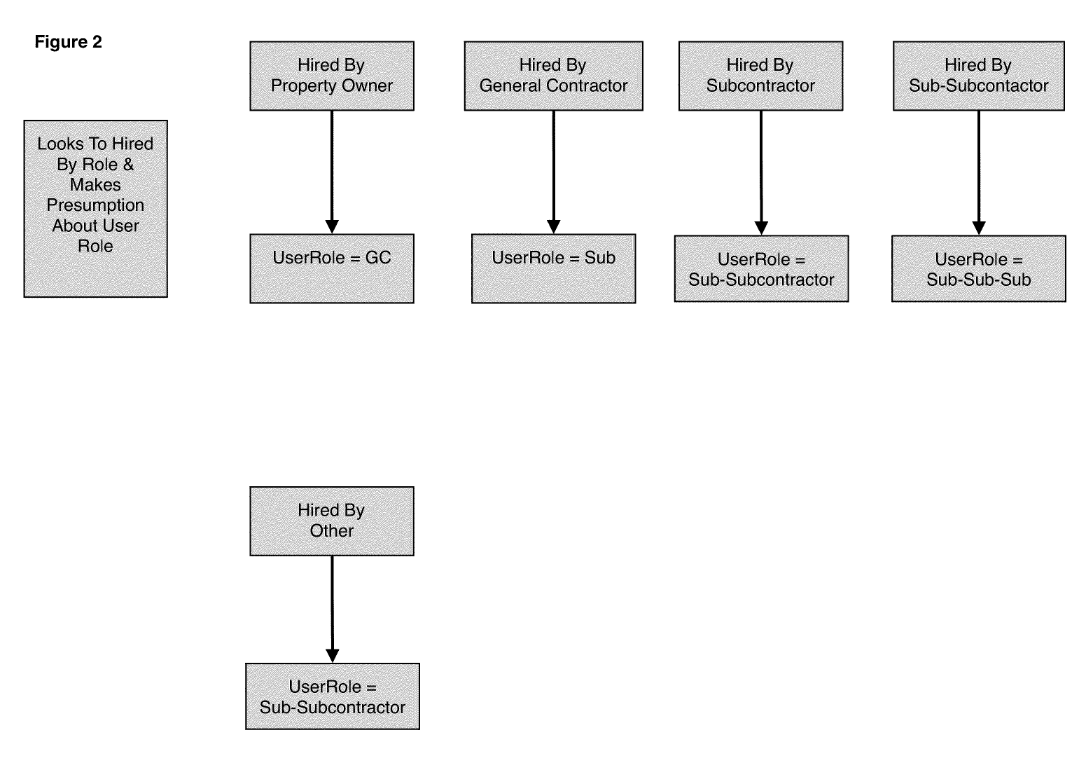

FIG. 3 is a graphical representation of the process employed by this invention if a project type data element is missing.

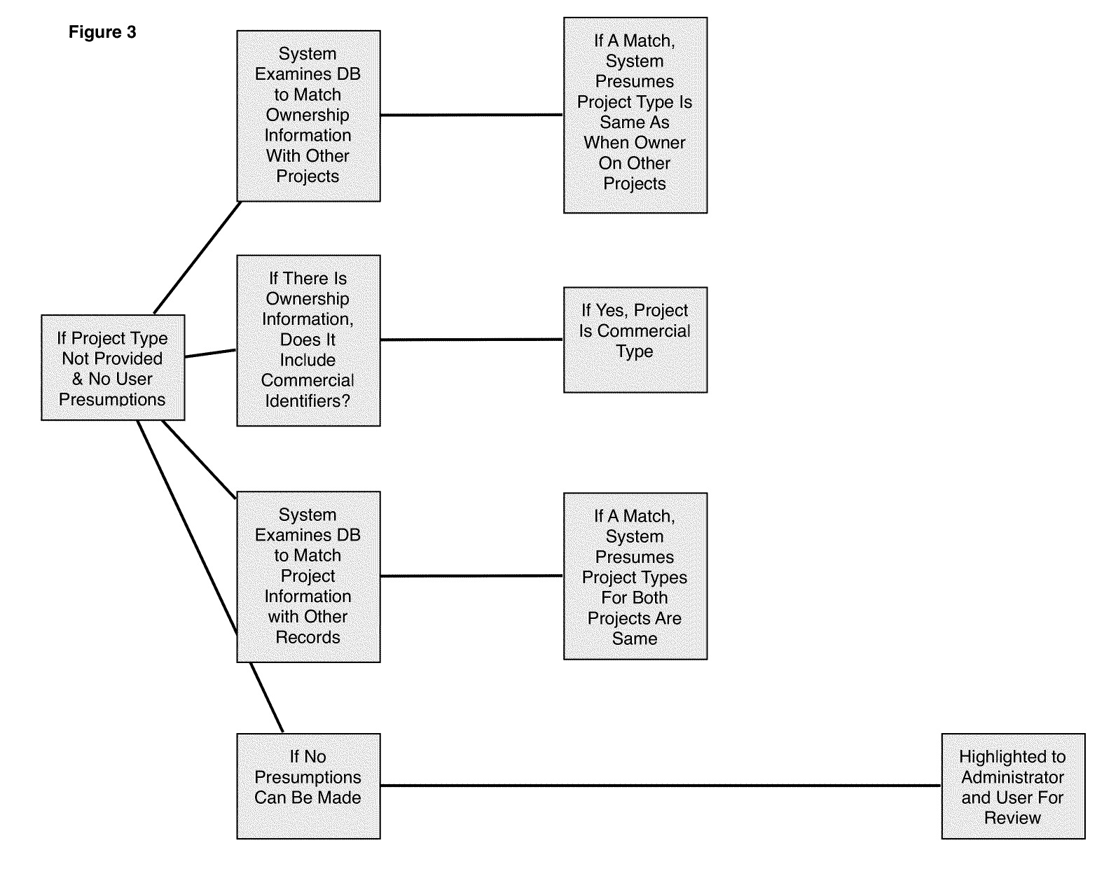

FIG. 4 is a graphical representation of the process employed by this invention if a user role data element is missing.

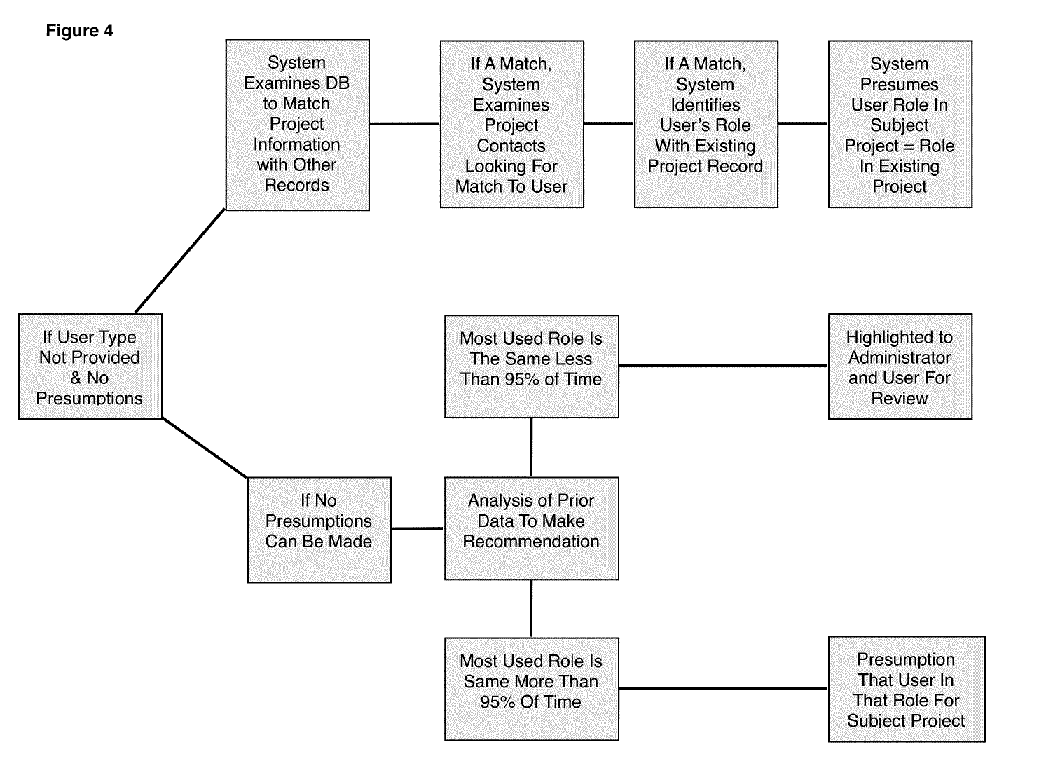

FIG. 5 is a graphical representation of the process employed by this invention if a date data element is missing.

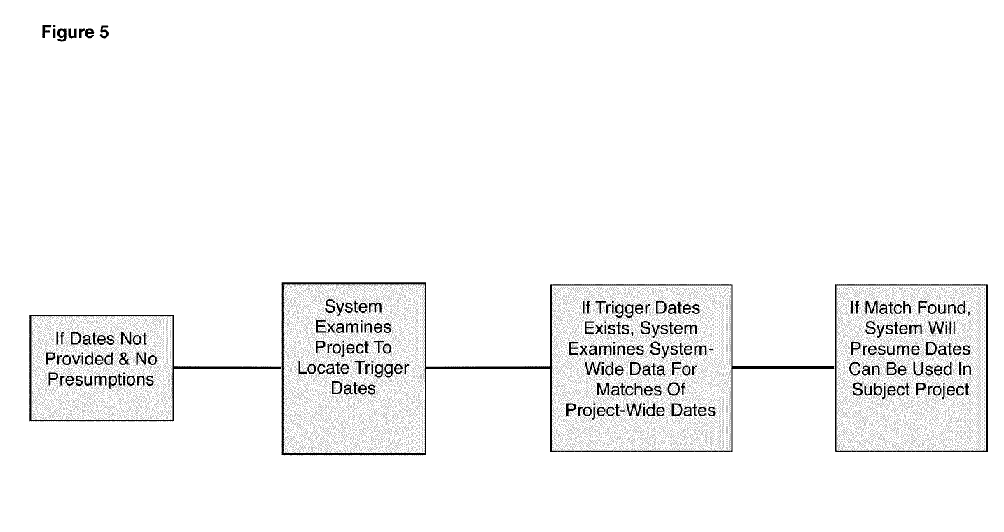

### DETAILED DESCRIPTION OF THE INVENTION

This invention, through a computer or computer program, is calculate construction lien, construction notice, bond claim, and other construction document requirements and deadlines based on system user provided information that may lack identification of critical data, by employing a system and method of utilizing presumptions, preexisting and dynamically building database information, user defaults, and/or other data elements, to supplement user provided information.

A. Explanation of the Data That May Be Missing or Inaccessible

A variety of systems and methods can be used to calculate and determine construction notice, lien, or bond claim deadlines and requirements. This invention does not claim the underlying process of utilizing specific user data to perform a deadline or requirement calculation or determination. This invention instead specifically relates to the use of certain system information (including default settings and existing data) to supplement user provided data, which enables a computer system or program to better understand the characteristics of a system user's subject construction project (the “project” or “project record”), and therefore, make a more accurate calculation or determination of the lien or bond claim compliance requirement.

Accordingly, since this invention relates to the supplementation of user data, it is relevant to review the universe of data that may apply to a construction project and may not be available or accessible to a system calculating or determining compliance needs.

First, the type of construction project, hereinafter referred to as “project type.” The parlance of the construction industry leaves the “project type” rather undefined, as projects are referred to by a variety of informal labels: school project, road project, federal job, state job, county job, city job, private job, public job, public work, residential job, commercial job, industrial job, and so on. Likewise, the parlance among legislators and jurists are no more organized, as projects are separated into new residential, existing residential, commercial, owner occupied residential, state, county, transportation, federal, and so on. Accordingly, it is common for the “project type” label needed to make a compliance determination to be unknown or unavailable from the knowledge or data available to a construction project participant.

Second, the user's role in a construction project, hereinafter referred to as “user role.” The role that a project participant plays in a construction project is very important to determine the compliance requirements for that party. Again, parlance is unregulated on a construction job, evidenced by the fact that a contracting party who contracts with the property owner may be referred to as a general contractor, prime contractor, direct contractor, GC, contractor, and more. The role of a party is critical to compliance determinations because states and the federal government regulates parties differently depending on their “role” in a project, which is typically defined by each applicable state statute. Roles may include general contractor, subcontractor, sub-subcontractor, sub- sub-subcontractor, supplier, equipment less, and so on.

Third, and similar to the user role is the hired-by role of a party on a project, hereinafter referred to as a “hired-by role.” While the “user role” identifies the role of the system user on a project, the “hired-by role” identifies the role of the project participant who hired the user. This is important because laws oftentimes distinguish on compliance requirements depending on the role of the party that hired a participant, and further, by the “tier” of a party within the contracting chain. It is possible to substitute “hired-by role” for the identification of a tier, and vice versa, and sometimes, depending on the circumstances, even the “user role.” Nevertheless, it is common for the participants and the systems they employ to lack any identification of the “role” of their customer.

Fourth, critical triggering dates, hereinafter referred to as “dates” or “trigger dates.” Dates are data elements critical to the function of determining or calculating a deadline to perform a compliance action, as a compliance action likely is required within a certain period of time that beings to run upon the happening of a trigger date. Project management system, accounting systems, ERPs, and other software platforms typically track dates like the date of invoice or date of opening an account. They do not, however, track the dates specifically required by the various state and federal statutes. Again, these statutory dates are labeled different and are substantially different depending on jurisdiction and circumstance. Accordingly, it is common for project participants and the systems they employ to lack any identification of the dates necessary for a calculation or determination of compliance items.

B. System User Preferences To Establish Defaults

Part A of this detailed description outlines some of the common data missing, unknown, or unattainable about a construction project that may be required by a system, method, or process to perform some calculation of mechanics lien or bond claim compliance requirements. This Part B of the detailed description details a method and process for system users to establish certain data defaults within a computer program, system, or platform.

This invention does not claim the underlying process of enabling a system user to establish general defaults or general data defaults within a system.

Instead, the invention claims a method to enable system users to establish data defaults, that may or may not be dependent on rules and circumstances, which will be used for the purpose of performing a process, through a computer or computer system, to analyze the defaults, and other existing data, as further explained in Parts C and D of this detailed description, to supplement missing information to complete known data about a construction project record, enabling a system to calculate and determine bond and lien claim deadlines.

In line with the four items discussed in the above Part A, which is likely to be missing about a construction project record, the invention contemplates that the system user may—through any method, process, or system of creating “rules,” which are commonly referred to as “if” and “then” rules, or “if this then that” rules—create rules and defaults for their account.

These rules will be stored, by the computer or computer program, into the computer's database, data source, or scripts, using any method, process, or system.

The rules may relate to the four frequently missing items discussed in Part A. They may establish rules for the system user as follows, serving as examples only:
Default project type for all projects
Default project type when a project is in a certain state, county, city or zip code
Default project type whenever project is associated with a certain location, branch, user account, etc.
Default user role for all projects
Default user role when a customer is a certain party;
Default user role when a project is associated with a certain location, branch, user account, etc.
Default hired-by role for all projects
Default hired-by role when a customer is a certain party;
Default hired-by role when a project is associated with a certain location, branch, user account, etc.
Default dates are entered by calculating days from previously entered dates, or other date records within the data available
Default dates based on hired-by parties
Default dates for all projects

C. Method and System of Using Established Defaults and Existing Data to Supplement Missing Information

Part A of this detailed description outlines some of the common data missing, unknown, or unattainable about a construction project that may be required by a system, method, or process to perform some calculation of mechanics lien or bond claim compliance requirements. Part B of the detailed description explains how a system user may be enabled to establish certain data defaults within a computer program, system, or platform, which can dictate how certain missing data is supplemented. This Part C discusses data available to a system, as contemplated herein, that can be examined for relevance related to individual records inputted into the system, database, computer platform, software, or program, by a system user, and outlines a method using both the default data from Part B, supra, and the system data, to supplement the user's data about a construction project to enable the user to calculate or determine a compliance requirement.

This invention does not claim the underlying process of enabling a system user to establish general defaults or general data defaults within a system, nor does it claim the underlying process of examining data stored within a system to draw conclusions.

Instead, the invention claims a method to enable system users to establish data defaults, that may or may not be dependent on rules and circumstances, and to supplement those defaults with certain known data, which, together, will be used for the purpose of performing a process, through a computer or computer system, to analyze the defaults, and other existing data, to supplement missing information to complete known data about a construction project record, enabling a system to calculate and determine bond and lien claim deadlines.

The method and system of examining and analyzing, by the computer or computer program, the system user's defaults and other data within the system, program, database, or data source, to supplement missing information to complete known data about a construction project record, comprises the following steps:

a.

Identifying, by the computer or computer program, the data needed to make a calculation and the data available for the calculation, by performing the following steps:
i. Examining, by the computer or computer program, the deadline or requirement calculation methodology, and extracting the data elements required to perform the calculation, including any data elements that are not required but can be used to assist in or improve the calculation;
ii. Examining, by the computer or computer program, the project record subject to the calculation or determination task, and extracting the data elements contained within or association with the subject project record that are required to perform, or will improve, the calculation;
iii. Identifying, by the computer or computer program, by comparing the data extracted from (i) and (ii) above, which data can be utilized from (i) which is missing from (ii), and establishing this data, by the computer or computer program through the performance of this method, system, and process, as the “missing data.”

b.

Examining, by the computer or computer program, whether the system user has any defaults established and associated with the system user's record, as stored within a computer program, database, script, or data source, and usable for the purposes of supplementing the “missing data,” consisting of the following steps:
i. If a default record matching the “missing data” is associated with a system account and contains rules for its applicability, then this method requires an examination, by the computer or computer program, of the subject project record and its associated records, to determine if the rules are met and the default record applies, and if so, for the computer or computer program to consider the default record as usable for supplementation, as contemplated herein;
ii. If a default record matching the “missing data” is associated with a system account and does not contain rules for applicability, to consider, by the computer or computer program, the default record as usable for supplementation as contemplated herein;
1. If, through the process explained in the above steps (b)(i) and (b)(ii), usable default data is located by the computer or computer program, which will match and supplement certain “missing data,” then this method will create, by the computer or computer program, a record of the supplemental data for the system user, as it relates to the project record and the function of—through any method—calculating or determining lien and bond claim compliance requirements;
2. Examining, by the computer or computer program, whether any “missing data” remains, and if so, to continue to step c. If not, and all missing data is fulfilled by the method up to this point, then the method of calculating or determining the compliance requirements shall be performed utilizing the system user's standard data, and the supplemented data based on defaults;

c. Examining, by the computer or computer program, the “missing data” remaining after performing steps (a) and (b) of this method and system, and thereafter, looking to system data to make presumptions that can supplement the missing data, comprising the following steps, depending on the data type:
i. When the missing data is the “project type,” this invention contemplates performing one or more than one of the following processes:
1. Examine, by the computer or computer program, whether the subject project record is associated with information about who owns the subject project, and if so, to examine, by the computer or computer program, the system's entire universe of data, whether stored within a database, data source, or otherwise, and to extract any other project records associated with the same project owner, and for those located projects to further extract, by the computer or computer program, the project type identifier(s) assigned to those projects;
2. Examine, by the computer or computer program, the system's entire universe of data, whether stored within a database, data source, or otherwise, and to extract any other project records that are substantially similar to the subject project record, and if such projects are located, to extract, by the computer or computer program, the project type identifier(s) assigned to those projects;
3. Examine, by the computer or the computer program, whether the subject project record is associated with information about who owns the subject project, and if so, to examine the name of the subject project owner and determine whether it is contains any “white label” identifiers which would suggest the project type; regarding said “white label” identifiers:
A. A list of white label identifiers would be established and stored within the computer program, script, software, database, or data source, and may be established as unique to each system user, and/or applicable system-wide;
B. White label identifiers are key characters or character strings that, when appearing within a name of a project owner, would strongly indicate a certain project type. For example, the terms “Inc.” and “Incorporated” in an owner name would strongly indicate a commercial project type, but a term like “US Army Corps of Engineers,” or “USACE” would strongly indicate a federal project type.
C. If, after examination by the computer or computer program, a white label identifier is located within the project record's affiliated owner, to extract, by the computer or computer program, the project type identifer(s) affiliated with the identified white label.
2. Determine, by the computer or computer program, a presumption project type by performing the following:
A. Collecting, by the computer or computer program, the project type identifiers extracted from the above subpart (c)(i) process; and
B. Comparing, by the computer or computer program, those identifiers, and determining if they are all the same, or if any are unique; and
C. If all of the project identifiers are the same, using the associated project type as the “presumptive” project type, and if there are no results, or if the results conflict with one another, then to not create presumptive project type.
ii. When the missing data is the “user role,” this invention contemplates performing one or more than one of the following processes:
1. Examine, by the computer or computer program, the system's entire universe of data, whether stored within a database, data source, or otherwise, and to extract any other project records that are substantially similar to the subject project record, and if such projects are located, to extract, by the computer or computer program, the whether the current system user appears associated with that project record in any way, and if so, then to extract, by the computer for computer program, the user role identifier(s) assigned to the user for that project;
2. Examine, by the computer or computer program, the subject project record and determine if the record contains a reference to the system user's “hired-by role” for the subject project, and if so, then to calculate, by the computer or computer program, the user role based thereupon, using a formula set in the computer database or script that assigns presumptive user roles based on hired-by roles, such as, for example, that when the hired by role is property owner the presumptive user role is general contractor, or as another example, when the hired by role is general contractor, the presumptive user role is subcontractor, and to extract, the user role identifier that results from that calculation.
3. Examine, by the computer or computer program, the system user's universe of associated projects within the system data, stored within a database, data source, or otherwise, and to extract the user role on each of the projects therein, and to determine if a specific user role identifier repeats for the user more than 90% of the time, and if so, to extract that repeating user role identifier;
4. Determine, by the computer or computer program, a presumption user role by performing the following:
D. Collecting, by the computer or computer program, the user role identifiers extracted from the above subpart (c)(ii) process; and
E. Comparing, by the computer or computer program, those identifiers, and determining if they are all the same, or if any are unique; and
F. If all of the user role identifiers are the same, using the associated user role as the “presumptive” user role, and if there are no results, or if the results conflict with one another, then to not create presumptive user role.
iii. When the missing data is the “hired by role,” this invention contemplates performing the method and process of examining the universe of data, stored in a database, data source, or otherwise within the computer program, and extracting every possible hired-by role identifier, and then, for the purposes of this method and process, creating a presumptive hired by role equal to all possible hired by roles.
iv. When the missing data is a specific date or trigger date, this invention contemplates performing one or more than one of the following processes:
1. Examine, by the computer or computer program, the system's entire universe of data, whether stored within a database, data source, or otherwise, and to extract any other project records that are substantially similar to the subject project record, and if such projects are located, to extract, by the computer or computer program, all date records associated therewith. For this method and system, date records are associated with projects, contain a record of the date, and also contain some association with a descriptor for the records, with some associative data element distinguishing between those dates that “individually” relevant to a project, and those dates that are “project wide” or “master dates.” A project wide date is a date that is not unique to the particular system user, but instead, is applicable to all users that are associated with a project. In the computer or computer program's examination of the dates associated with substantially similar projects, the system and method shall extract, by the computer or computer program, all associated “project wide dates” date records;
2. Examine, by the computer or computer program, the system user's universe of associated projects within the system data, stored within a database, data source, or otherwise, and to extract an average date (related to the missing date) for projects, within the user's data, that are similar to the subject project;
3. Determine, by the computer or computer program, a presumption date by performing the following:
G. Collecting, by the computer or computer program, the date(s) extracted from the above subpart (c)(iv) process; and
H. Determining, by the computer or computer program, if the dates discovered will satisfy the missing dates data for the subject project;
I. Comparing, by the computer or computer program, the discovered dates with one another, to the extent they are the same date type, and determining if they are all within a five (5) day period of each, or if any are not within the range; and
J. If all of the dates are within the five (5) day period range, using the associated date as the “presumptive” date, and if they are outside of the range, then to not create presumptive date.
b. Collect, by the computer or computer program, all of the subject project record data, qualifying default data, and qualifying presumptive data, all of which applies to a method and system—of any sort—to calculate or determine mechanics lien or bond claim deadlines and requirements, and to utilize, by the computer or computer program, all of that date to perform the calculation function.
D. Communication of Errors, Incomplete Functions, and Augmentations To System User To Enable User Management, Oversight, and Supplementation On some occasions, the process and method outlined in this invention will be successful at supplementing missing information adequately enough to perform the function of calculating or determining deadlines or requirements with originally inadequate information. Furthermore, employment of this process and method will sometimes create scenarios when the missing data can be supplemented without ambiguity within the process.

However, the process may: (i) Not be successful in acquiring all of the missing data; and (ii) May not be successful at acquiring missing data in a way that is unambiguous; and (iii) May result in situations where supplemented data conflicts or is otherwise uncertain, and a presumptive date would not result.

This Part D of the invention contemplates a mechanism whereby missing, augmented, erroneous, or ambiguous data is highlighted within the system, computer, or computer program, or is otherwise highlighted and displayed to an administrator or user through user, device, or computer interface.

This part of the invention claims a computer implemented method and system of examining, by the computer or computer program, a system's project records that are subject to a process and method—of any type—of calculating or determining mechanics lien or bond claim deadlines, and of creating indicators for certain data that affect or deserve caution in the calculation or determination process, comprising of the following steps:

a.

Identifying, by the computer or computer program, the data needed to make a calculation and the data available for the calculation, by performing the following steps:
iv. Examining, by the computer or computer program, the deadline or requirement calculation methodology, and extracting the data elements required to perform the calculation, including any data elements that are not required but can be used to assist in or improve the calculation;
v. Examining, by the computer or computer program, the project record subject to the calculation or determination task, and extracting the data elements contained within or association with the subject project record that are required to perform, or will improve, the calculation;
vi. Identifying, by the computer or computer program, by comparing the data extracted from (i) and (ii) above, which data can be utilized from (i) which is missing from (ii), and establishing this data, by the computer or computer program through the performance of this method, system, and process, as the “missing data;”
vii. Examining, by the computer or computer program, any default data or presumptive data that was obtained through the process described in Part C, supra, and comparing that data with the “missing data” extracted through part (a)(iii) herein, and identifying, by the computer or computer program, what data remains missing.
c. Extracting, by the computer or computer program, all of the missing data, and displaying, by the computer or computer program through a user, device, or system interface, the record of the data that is missing, and enabling, through said interface, the user or administrator to complete the missing data, which when performed, would enable the system to utilize a process and method, of any sort, of calculating or determining the mechanics lien or bond claim compliance requirements for a project record.

What is claimed is:

1. A computer implemented method and system of examining and analyzing, by the computer or computer program, the system user's defaults and other data within the system, program, database, or data source, to supplement missing information to complete known data about a construction project record, comprises the following steps:
a. Identifying, by the computer or computer program, the data needed to make a calculation and the data available for the calculation, by performing the following steps: i. Examining, by the computer or computer program, the deadline or requirement calculation methodology, and extracting the data elements required to perform the calculation, including any data elements that are not required but can be used to assist in or improve the calculation; ii. Examining, by the computer or computer program, the project record subject to the calculation or determination task, and extracting the data elements contained within or association with the subject project record that are required to perform, or will improve, the calculation; iii. Identifying, by the computer or computer program, by comparing the data extracted from (i) and (ii) above, which data can be utilized from (i) which is missing from (ii), and establishing this data, by the computer or computer program through the performance of this method, system, and process, as the “missing data.”
b. Examining, by the computer or computer program, whether the system user has any defaults established and associated with the system user's record, as stored within a computer program, database, script, or data source, and usable for the purposes of supplementing the “missing data,” consisting of the following steps:
i. If a default record matching the “missing data” is associated with a system account and contains rules for its applicability, then this method requires an examination, by the computer or computer program, of the subject project record and its associated records, to determine if the rules are met and the default record applies, and if so, for the computer or computer program to consider the default record as usable for supplementation, as contemplated herein;
ii. If a default record matching the “missing data” is associated with a system account and does not contain rules for applicability, to consider, by the computer or computer program, the default record as usable for supplementation as contemplated herein;
1. If, through the process explained in the above steps (b)(i) and (b)(ii), usable default data is located by the computer or computer program, which will match and supplement certain “missing data,” then this method will create, by the computer or computer program, a record of the supplemental data for the system user, as it relates to the project record and the function of—through any method—calculating or determining lien and bond claim compliance requirements;
2. Examining, by the computer or computer program, whether any “missing data” remains, and if so, to continue to step c. If not, and all missing data is fulfilled by the method up to this point, then the method of calculating or determining the compliance requirements shall be performed utilizing the system user's standard data, and the supplemented data based on defaults;
c. Examining, by the computer or computer program, the “missing data” remaining after performing steps (a) and (b) of this method and system, and thereafter, looking to system data to make presumptions that can supplement the missing data, comprising the following steps, depending on the data type:
i. When the missing data is the “project type,” this invention contemplates performing one or more than one of the following processes:
1. Examine, by the computer or computer program, whether the subject project record is associated with information about who owns the subject project, and if so, to examine, by the computer or computer program, the system's entire universe of data, whether stored within a database, data source, or otherwise, and to extract any other project records associated with the same project owner, and for those located projects to further extract, by the computer or computer program, the project type identifier(s) assigned to those projects;
2. Examine, by the computer or computer program, the system's entire universe of data, whether stored within a database, data source, or otherwise, and to extract any other project records that are substantially similar to the subject project record, and if such projects are located, to extract, by the computer or computer program, the project type identifier(s) assigned to those projects;
3. Examine, by the computer or the computer program, whether the subject project record is associated with information about who owns the subject project, and if so, to examine the name of the subject project owner and determine whether it is contains any “white label” identifiers which would suggest the project type; regarding said “white label” identifiers:
A. A list of white label identifiers would be established and stored within the computer program, script, software, database, or data source, and may be established as unique to each system user, and/or applicable system-wide;
B. White label identifiers are key characters or character strings that, when appearing within a name of a project owner, would strongly indicate a certain project type. For example, the terms “Inc.” and “Incorporated” in an owner name would strongly indicate a commercial project type, but a term like “US Army Corps of Engineers,” or “USACE” would strongly indicate a federal project type.
C. If, after examination by the computer or computer program, a white label identifier is located within the project record's affiliated owner, to extract, by the computer or computer program, the project type identifer(s) affiliated with the identified white label.
4. Determine, by the computer or computer program, a presumption project type by performing the following:
A. Collecting, by the computer or computer program, the project type identifiers extracted from the above subpart (c)(i) process; and
B. Comparing, by the computer or computer program, those identifiers, and determining if they are all the same, or if any are unique; and
C. If all of the project identifiers are the same, using the associated project type as the “presumptive” project type, and if there are no results, or if the results conflict with one another, then to not create presumptive project type.
iii. When the missing data is the “user role,” this invention contemplates performing one or more than one of the following processes:
1. Examine, by the computer or computer program, the system's entire universe of data, whether stored within a database, data source, or otherwise, and to extract any other project records that are substantially similar to the subject project record, and if such projects are located, to extract, by the computer or computer program, the whether the current system user appears associated with that project record in any way, and if so, then to extract, by the computer for computer program, the user role identifier(s) assigned to the user for that project;
2. Examine, by the computer or computer program, the subject project record and determine if the record contains a reference to the system user's “hired-by role” for the subject project, and if so, then to calculate, by the computer or computer program, the user role based thereupon, using a formula set in the computer database or script that assigns presumptive user roles based on hired-by roles, such as, for example, that when the hired by role is property owner the presumptive user role is general contractor, or as another example, when the hired by role is general contractor, the presumptive user role is subcontractor, and to extract, the user role identifier that results from that calculation.
3. Examine, by the computer or computer program, the system user's universe of associated projects within the system data, stored within a database, data source, or otherwise, and to extract the user role on each of the projects therein, and to determine if a specific user role identifier repeats for the user more than 90% of the time, and if so, to extract that repeating user role identifier;
4. Determine, by the computer or computer program, a presumption user role by performing the following:
A. Collecting, by the computer or computer program, the user role identifiers extracted from the above subpart (c)(ii) process; and
B. Comparing, by the computer or computer program, those identifiers, and determining if they are all the same, or if any are unique; and
C. If all of the user role identifiers are the same, using the associated user role as the “presumptive” user role, and if there are no results, or if the results conflict with one another, then to not create presumptive user role.
iv. When the missing data is the “hired by role,” this invention contemplates performing the method and process of examining the universe of data, stored in a database, data source, or otherwise within the computer program, and extracting every possible hired-by role identifier, and then, for the purposes of this method and process, creating a presumptive hired by role equal to all possible hired by roles.
v. When the missing data is a specific date or trigger date, this invention contemplates performing one or more than one of the following processes:
1. Examine, by the computer or computer program, the system's entire universe of data, whether stored within a database, data source, or otherwise, and to extract any other project records that are substantially similar to the subject project record, and if such projects are located, to extract, by the computer or computer program, all date records associated therewith. For this method and system, date records are associated with projects, contain a record of the date, and also contain some association with a descriptor for the records, with some associative data element distinguishing between those dates that “individually” relevant to a project, and those dates that are “project wide” or “master dates.” A project wide date is a date that is not unique to the particular system user, but instead, is applicable to all users that are associated with a project. In the computer or computer program's examination of the dates associated with substantially similar projects, the system and method shall extract, by the computer or computer program, all associated “project wide dates” date records;
2. Examine, by the computer or computer program, the system user's universe of associated projects within the system data, stored within a database, data source, or otherwise, and to extract an average date (related to the missing date) for projects, within the user's data, that are similar to the subject project;
3. Determine, by the computer or computer program, a presumption date by performing the following:
A. Collecting, by the computer or computer program, the date(s) extracted from the above subpart (c)(iv) process; and
B. Determining, by the computer or computer program, if the dates discovered will satisfy the missing dates data for the subject project;
C. Comparing, by the computer or computer program, the discovered dates with one another, to the extent they are the same date type, and determining if they are all within a five (5) day period of each, or if any are not within the range; and
D. If all of the dates are within the five (5) day period range, using the associated date as the “presumptive” date, and if they are outside of the range, then to not create presumptive date.
d. Collect, by the computer or computer program, all of the subject project record data, qualifying default data, and qualifying presumptive data, all of which applies to a method and system—of any sort—to calculate or determine mechanics lien or bond claim deadlines and requirements, and to utilize, by the computer or computer program, all of that date to perform the calculation function.

2. The method of claim 1 wherein the entire process and method is performed, or if any component of the method or process is performed by the computer or computer program, individually, to supplement missing information to complete known data about a construction project record, for the purposes of using a method or system—of any sort—to calculate or determine mechanics lien or bond claim deadlines and requirements.

3. The method of claim 1 wherein any number of components of the process and method is performed to supplement missing information to complete known data about a construction project record, for the purposes of using a method or system—of any sort—to calculate or determine mechanics lien or bond claim deadlines and requirements.

4. The method of claim 1, except that when the computer is examining and extracting data from the system, program, database, or data source, to create presumptive dates, instead of requiring the discovered data to match perfectly, a scoring system is implemented to score the data found through the method and system, and the usability of said data relying on the attained score.

5. A computer implemented method and system of examining, by the computer or computer program, a system's project records that are subject to a process and method—of any type—of calculating or determining mechanics lien or bond claim deadlines, and of creating indicators for certain data that affect or deserve caution in the calculation or determination process, comprising of the following steps:
a. Identifying, by the computer or computer program, the data needed to make a calculation and the data available for the calculation, by performing the following steps:
i. Examining, by the computer or computer program, the deadline or requirement calculation methodology, and extracting the data elements required to perform the calculation, including any data elements that are not required but can be used to assist in or improve the calculation;
ii. Examining, by the computer or computer program, the project record subject to the calculation or determination task, and extracting the data elements contained within or association with the subject project record that are required to perform, or will improve, the calculation;
iii. Identifying, by the computer or computer program, by comparing the data extracted from (i) and (ii) above, which data can be utilized from (i) which is missing from (ii), and establishing this data, by the computer or computer program through the performance of this method, system, and process, as the “missing data;”
iv. Examining, by the computer or computer program, any default data or presumptive data that was obtained through the process described in claim 1, supra, and comparing that data with the “missing data” extracted through part (a)(iii) herein, and identifying, by the computer or computer program, what data remains missing.
b. Extracting, by the computer or computer program, all of the missing data, and displaying, by the computer or computer program through a user, device, or system interface, the record of the data that is missing, and enabling, through said interface, the user or administrator to complete the missing data, which when performed, would enable the system to utilize a process and method, of any sort, of calculating or determining the mechanics lien or bond claim compliance requirements for a project record.

6. The method of claim 5, except that subpart (a)(iv) is not performed.

7. The method of claim 5, except that subpart (b) is replaced with: “Extracting, by the computer or computer program, all of the missing data, and providing, by the computer or computer program through an electronic mailing, RSS feed, or other electronic transmission or notification, the record of the data that is missing, and enabling, through a user, device, or computer interface, the user or administrator to complete the missing data, which when performed, would enable the system to utilize a process and method, of any sort, of calculating or determining the mechanics lien or bond claim compliance requirements for a project record.”

8. The method of claim 6, except that subpart (b) is replaced with: “Extracting, by the computer or computer program, all of the missing data, and providing, by the computer or computer program through an electronic mailing, RSS feed, or other electronic transmission or notification, the record of the data that is missing, and enabling, through a user, device, or computer interface, the user or administrator to complete the missing data, which when performed, would enable the system to utilize a process and method, of any sort, of calculating or determining the mechanics lien or bond claim compliance requirements for a project record.”

9. The method of claim 5, except that subpart (b) is replaced with: “Extracting, by the computer or computer program, all of the missing data, and providing, by the computer or computer program through the download or transmission of a csv, xml, txt, xls, or similar data file, the record of the data that is missing, and enabling, through a user, device, or computer interface, or by making changes within the sent file itself, the user or administrator to complete the missing data, which when performed, would enable the system to utilize a process and method, of any sort, of calculating or determining the mechanics lien or bond claim compliance requirements for a project record.”

10. The method of claim 6, except that subpart (b) is replaced with: “Extracting, by the computer or computer program, all of the missing data, and providing, by the computer or computer program through the download or transmission of a csv, xml, txt, xls, or similar data file, the record of the data that is missing, and enabling, through a user, device, or computer interface, or by making changes within the sent file itself, the user or administrator to complete the missing data, which when performed, would enable the system to utilize a process and method, of any sort, of calculating or determining the mechanics lien or bond claim compliance requirements for a project record.”
